(19) United States
(12) Patent Application Publication
(10) Pub. No.: US 2008/0220626 A1
(43) Pub. Date: Sep. 11, 2008

(54) Electronic product connection means

(75) Inventor: Shih-Kun Yeh, Luchu Hsiang (TW)

Correspondence Address: TROXELL LAW OFFICE PLLC, SUITE 1404, 5205 LEESBURG PIKE, FALLS CHURCH, VA, 22041, US

(73) Assignee: TENNRICH INTERNATIONAL CORP.

(21) Appl. No.: 11/715,505

(22) Filed: Mar. 8, 2007

(51) Int. Cl. H01R 12/00

(52) U.S. Cl. 439/67

(57) ABSTRACT

An electronic product connection means to correct the problem of higher costs involved in the only use of a flexible print circuit includes flexible flat cable and electronic cabling material with both connected and secured in position by a locating means; flexibility of the electronic cabling material allowing it be designed into different shape or bent depending on a circuit board provided for the connection means to be applied in various types of electronic products, e.g., at where between display panel and signal control circuit in a Notebook.

### BACKGROUND OF THE INVENTION

(a) Field of the Invention

The present invention is related to an electronic product connection means, and more particularly, to one that achieves electric connection among different circuit devices.

(b) Description of the Prior Art

Whereas a flexible print circuit is related to one that allows be bending and deflecting to significantly save space it consumes, it is comprehensively applied in various types of electronic products, particularly in compact and portable ones including Notebook, cellular phone, digital camera, portable VCD/DVD, and car laden display. In practical application, a flexible print circuit usually functions as a connector to connect different circuit devices; for example, one that is adapted to where between a display panel and a signal control circuit to transmit video signal to the display panel while controlling the video display on the display panel.

Referring to FIG. 1 of the accompanying drawings for a schematic view showing a flexible print circuit applied for connection in a Notebook, a display area 12 is provided at the center of a liquid crystal display panel 11 of a Notebook 1; a peripheral circuit area 13 is disposed surrounding the display area 12; and multiple drive circuits 14 are placed on the peripheral circuit area 13. Those multiple drive circuits 14 are connected by means of a flexible print circuit (FPC) 2 to a keyboard or an input means 3. Control signals inputted from the keyboard or the input means 3 are transmitted through the FPC 2 to those driver circuits 14 for the display area 12 to display corresponding image. The connection between the FPC 2 and the keyboard or the input means 3 can be designed in various forms as required due to flexibility of the FPC 2 to compromise the appearance of other circuit devices (e.g., a circuit board). However, the cost of the flexible print circuit is comparatively higher to fail meeting economic benefits.

### SUMMARY OF THE INVENTION

The primary purpose of the present invention is to provide an electronic product connection means to correct the problem of higher cost involving the only use of a flexible print circuit. To achieve the purpose, the present invention is essentially comprised of flexible flat cable (FFC) and an electronic cabling material, and a locating structure to connect in position the FFC and the cabling material to each another. The cabling material may be related to twist cable, Taflon insulated cable, or Polyvinylchloride (PVC) cable or the equivalent that is flexible and allows to be designed in different shapes of route or bent into a shape for compromising the circuit board provided. The electronic product connection means of the present invention can be applied in various types of electronic products including in a Notebook to connect its display panel and signal control circuit.

### BRIEF DESCRIPTION OF THE DRAWINGS

FIG. 1 is a schematic view showing a flexible print circuit of the prior art applied in the design of connection for a Notebook.

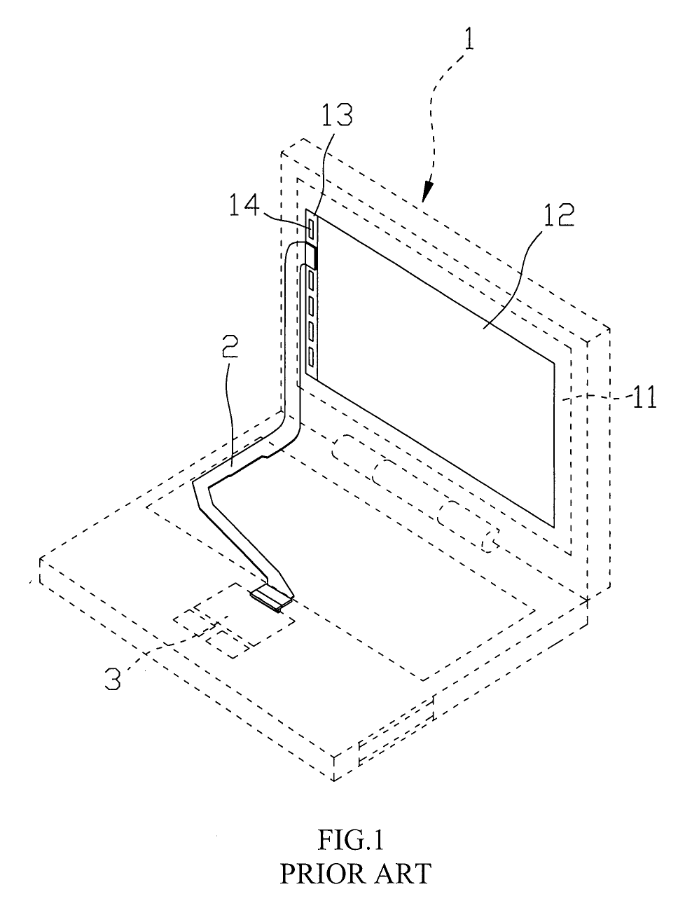

FIG. 2 is a schematic view showing a connection design of a first preferred embodiment of the present invention applied in a Notebook.

FIG. 3 is a schematic view showing a structure of a locating means in the first preferred embodiment of the present invention.

FIG. 4 is a schematic view showing another structure of a locating means in the first preferred embodiment of the present invention.

FIG. 5 is a schematic view showing another structure yet of a locating means in the first preferred embodiment of the present invention.

FIG. 6 is a schematic view showing a locating means in a second preferred embodiment of the present invention.

FIG. 7 is a schematic view showing another structure of a locating means in the second preferred embodiment of the present invention.

FIG. 8 is a schematic view showing another structure yet of a locating means in the second preferred embodiment of the present invention.

### DETAILED DESCRIPTION OF THE PREFERRED EMBODIMENTS

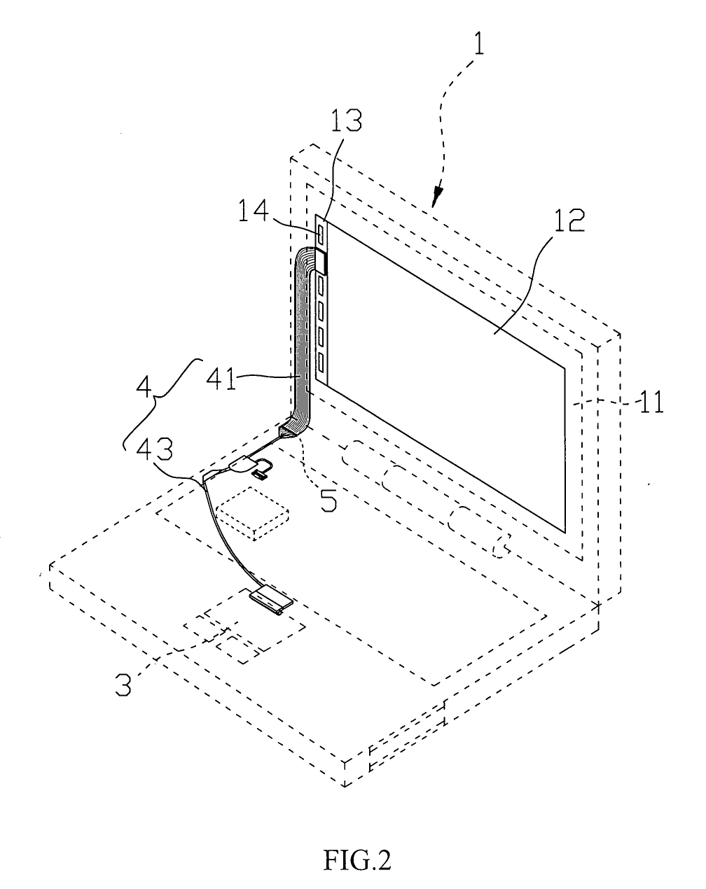

Referring to FIG. 2 for an electronic product connection means of the present invention, a connection means 4 is essentially comprised of a flexible flat cable (FFC) 41, and an electronic cabling material 43. Wherein, the connection means may be applied in a portable electronic product including a Notebook, a cellular phone, a digital camera, a portable VCD/DVD, or a car-laden display. According to a preferred embodiment as illustrated in FIG. 2, the connection means 4 is applied in a Notebook 1. A display area 12 is provided at the center of a liquid crystal display panel 11 of the Notebook 1; a peripheral circuit area 13 is disposed surrounding the display area 12; and multiple drive circuits 14 are disposed on the peripheral circuit area 13. Wherein, those drive circuits 14 are first connected to and secured in position to the electronic cabling material 43 through a flexible flat cable 41 and a locating means 5, and the electronic cabling material 43 is then connected to a keyboard or an input means 3 for control signals inputted from the keyboard or the input means 3 are transmitted through the connection means 4 to those drive circuits 14 for the display area 12 to display a corresponding image. Connection to each other by and between the electronic cabling material 43 and the keyboard or the input means 3 can be designed into a circuit in different shapes due to the flexibility of the electronic cabling material 43 to compromise the shape of other circuit device (e.g., a circuit board).

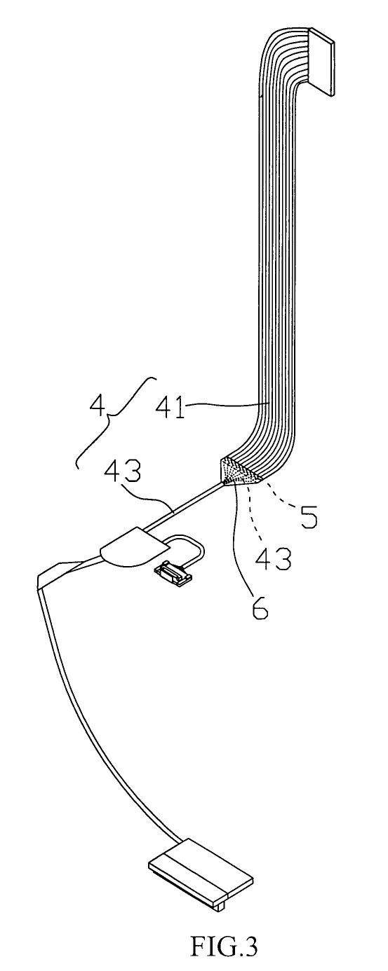

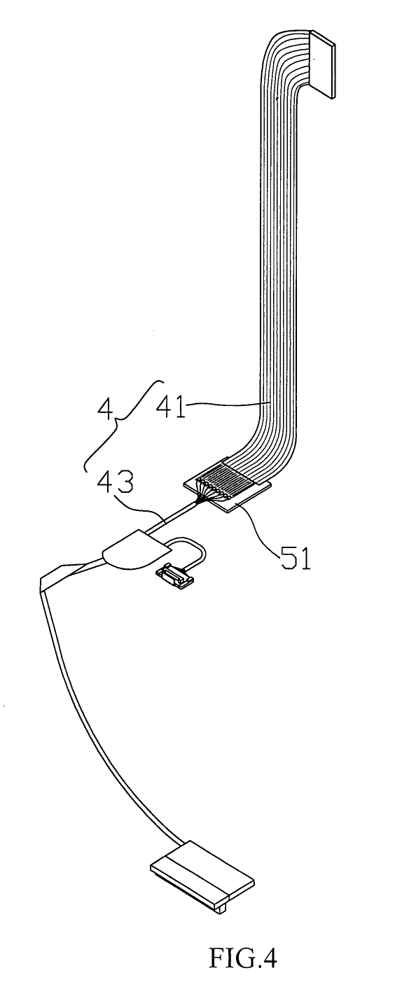

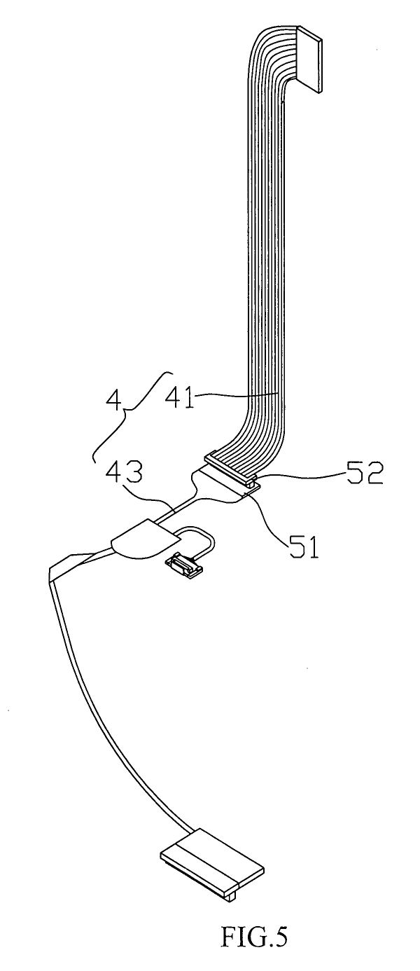

In practice, the locating means 5 at where between the flexible flat cable (FFC) 41 and the electronic cabling material 43 as illustrated in FIGS. 2 and 3 is secured by soldering and is further wound up with a covering material 6 to protect the electronic cabling material 43 and its locating means 5; or alternatively as illustrated in FIG. 4, a circuit board 51 is provided to respectively locate both of the flexible flat cable (FFC) 41 and the electronic cabling material 43 on both sides of the circuit board 51 to achieve the connection in position between the flexible flat cable (FFC) 41 and the electronic cabling material 43 through the circuit board 51. Wherein, the circuit board 51 relates to a regular hard Printed circuit board (PCB) or a flexible print circuit; or as illustrated in FIG. 5, a connector 52 is provided to connect and secure in position both of the flexible flat cable (FFC) 41 and the electronic cabling material 43 to each other.

The electronic cabling material 43 is related to a twist cable, a Taflon insulated cable, a PVC cable, or any equivalent flexible electronic cabling material.

The present invention by providing both of the flexible flat cable and the electronic cabling material connected to each other in position by means of the locating means can be installed in electronic product including a notebook at where between a display panel and a single control circuit to correct the problem of higher costs of the prior art due to the only use of a flexible print circuit. Furthermore, by taking advantage of its flexibility, a twist cable, a Taflon insulated cable, or a PVC cable may be designed or bent according to a circuit board provided into a shape of route for meeting the shape of other circuit device (e.g., a circuit board).

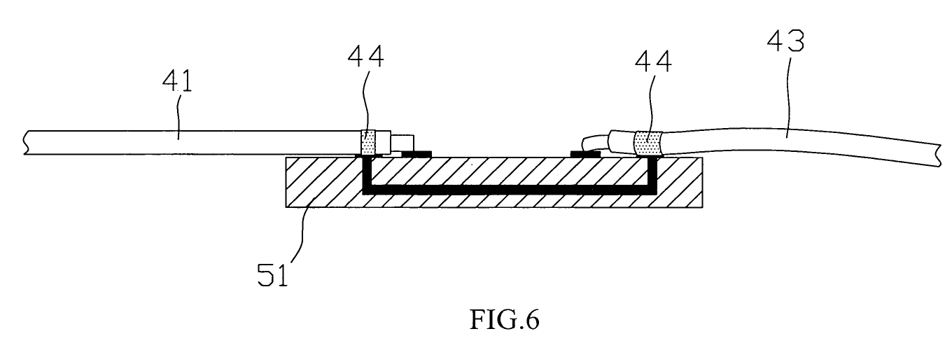

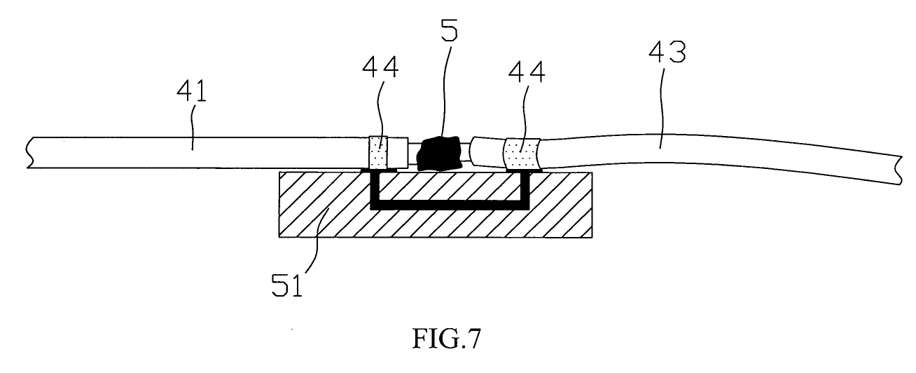

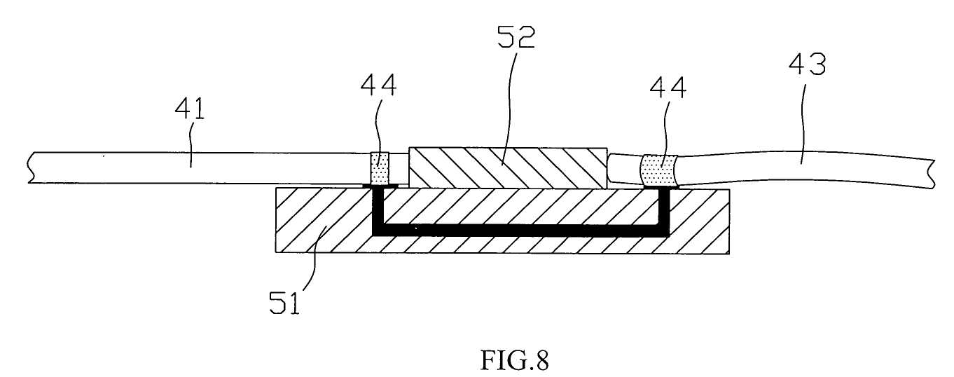

Furthermore, the connection means of the present invention may take advantage of the locating means to provide electromagnetic interference (EMI) prevention characteristics to avoid adverse effects of wild function, transmission error and poor message transmitted due to interference from magnetic field and electromagnetic waves. As illustrated in FIG. 6 for a schematic view of a construction of having a circuit board to connect the flexible flat cable (FFC) 41 and the electronic cabling material 43, a conductive material 44 (using a conductive plastic tape to cover up the flexible flat cable and the electronic cabling material) is provided at where both of the flexible flat cable (FFC) 41 and the electronic cabling material 43 close to the circuit board 51; and the conductive material 44 is connected to the circuit board 51 so to lead out magnetic field and electromagnetic field waves to prevent EMI. Of course, if the locating means relates to a soldering structure or a connector, the same EMI prevention purpose can be also achieved by fixing a circuit board 51 on one side of the soldering structure or a connector 52 as illustrated in FIGS. 7 and 8, and the conductive material 44 is disposed at where both of the flexible flat cable (FFC) 41 and the electronic cabling material 43 are close to the circuit board 51 and further connected to the circuit board 51 to lead out those waves from the magnetic field and the electromagnetic filed.

The prevent invention provides an improved structure of a connector for electronic product, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An electronic product connection means is essentially comprised of a flexible flat cable (FFC) and an electronic cabling material, and a locating means to connect and secure in position the flexible flat cable (FFC) and the electronic cabling material.

2. The electronic product connection means as claimed in claim 1, wherein the electronic cabling materials relates to a twist cable, a Taflon insulated cable, or a PVC cable.

3. The electronic product connection means as claimed in claim 1, wherein the locating means relates to a soldering structure.

4. The electronic product connection means as claimed in claim 3, wherein a circuit board is fixed on one side of the soldering structure, and a conductive material connected to the circuit board is disposed at where both of the flexible flat cable (FFC) and the electronic cabling material are close to the soldering structure.

5. The electronic product connection means as claimed in claim 1, wherein the locating means relates to a circuit board.

6. The electronic product connection means as claimed in claim 5, wherein the circuit board is related to a hard PCB or a flexible print circuit (FPC).

7. The electronic product connection means as claimed in claim 5, wherein a conductive material connected to the circuit board is disposed at where both of the flexible flat cable (FFC) and the electronic cabling material are close to the circuit board.

8. The electronic product connection means as claimed in claim 1, wherein the locating means relates to a connector.

9. The electronic product connection means as claimed in claim 8, wherein a circuit board is fixed on one side of the connector, and a conductive material connected to the electronic cabling material is disposed at where both of the flexible flat cable (FFC) and the electronic cabling material are close to the connector.

10. The electronic product connection means as claimed in claim 6, wherein a conductive material connected to the circuit board is disposed at where both of the flexible flat cable (FFC) and the electronic cabling material are close to the circuit board.
